(19) United States
(12) Patent Application Publication
(10) Pub. No.: US 2016/0239736 A1
(43) Pub. Date: Aug. 18, 2016

(54) METHOD FOR DYNAMICALLY UPDATING CLASSIFIER COMPLEXITY

(71) Applicant: QUALCOMM Incorporated, San Diego, CA (US)

(72) Inventor: Anthony SARAH, San Diego, CA (US)

(21) Appl. No.: 14/624,500

(22) Filed: Feb. 17, 2015

(51) Int. Cl. G06N 3/08; G06N 3/04

(52) U.S. Cl. CPC G06N 3/08; G06N 3/04

(57) ABSTRACT

A method for configuring a classifier includes operating the classifier to classify an input. The method also includes determining a confidence metric based on classification of the input. The method further includes dynamically updating a complexity of the classifier based on the confidence metric. The confidence metric may be computed based on a posterior probability. The complexity may be updated when the confidence metric is below a threshold value.

### BACKGROUND

1. Field

Certain aspects of the present disclosure generally relate to machine learning and, more particularly, to systems and methods for dynamically updating the complexity of a classifier.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks.

Convolutional neural networks are a type of feed-forward artificial neural network. Convolutional neural networks may include layers of neurons that may be configured in a tiled receptive field. Convolutional neural networks (CNNs) have numerous applications. In particular, CNNs have broadly been used in the area of pattern recognition and classification.

Deep learning architectures, such as deep belief networks and deep convolutional networks, have increasingly been used in object recognition applications. Like convolutional neural networks, computation in these deep learning architectures may be distributed over a population of processing nodes, which may be configured in one or more computational chains. These multi-layered architectures offer greater flexibility as they may be trained one layer at a time and may be fine-tuned using back propagation.

Deep belief networks (DBNs) are probabilistic models made up of multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. The bottom RBMs of the DBN may serve as feature extractors and the top RBM may serve as a classifier.

Although deep networks such as deep belief networks and deep convolutional networks achieve excellent results on a number of classification benchmarks, their computational complexity can be prohibitively high. The prohibitively high computational complexity can be mitigated when using clusters of central processing units (CPUs) or graphics processing units (GPUs). However, when trying to support these networks on less capable platforms, such as single CPUs or digital signal processors (DSPs), the computational complexity may preclude their use. Users of these models may be forced to analyze the network and make simplifications, which may decrease classification performance of the network.

The process of analyzing a deep network-based classifier to determine which simplifications would allow implementing it on a given platform is difficult. In addition, the simplifications that allow implementation may be detrimental to classification performance.

### SUMMARY

In an aspect of the present disclosure, a method of configuring a classifier is presented. The method comprises operating the classifier to classify an input. The method also comprises determining a confidence metric based on the classification of the input. The method further comprises dynamically updating a complexity of the classifier based on the confidence metric.

In another aspect of the present disclosure, an apparatus for configuring a classifier is presented. The apparatus includes a memory and at least one processor coupled to the memory. The processor(s) is(are) configured to operate the classifier to classify an input. The processor(s) is(are) also configured to determine a confidence metric based on the classification of the input. The processor(s) is(are) further configured to dynamically update a complexity of the classifier based on the confidence metric.

In yet another aspect of the present disclosure, an apparatus for configuring a classifier is presented. The apparatus includes means for operating the classifier to classify an input. The apparatus also includes means for determining a confidence metric based on the classification of the input. The apparatus further includes means for dynamically updating a complexity of the classifier based on the confidence metric.

In still another aspect of the present disclosure, a computer program product for configuring a classifier is presented. The computer program product includes a non-transitory computer readable medium having encoded thereon program code. The program code includes program code to operate the classifier to classify an input. The program code also includes program code to determine a confidence metric based on the classification of the input. The program code further includes program code to dynamically update a complexity of the classifier based on the confidence metric.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3A is a high-level block diagram illustrating an exemplary classifier in accordance with an aspect of the present disclosure.

FIG. 3B illustrates an example implementation of a classifier using a general-purpose processor in accordance with certain aspects of the present disclosure.

FIG. 4 illustrates an example implementation of designing a neural network where a memory may be interfaced with individual distributed processing units in accordance with certain aspects of the present disclosure.

FIG. 5 illustrates an example implementation of designing a neural network based on distributed memories and distributed processing units in accordance with certain aspects of the present disclosure.

FIG. 6 illustrates an example implementation of a neural network in accordance with certain aspects of the present disclosure.

FIG. 7 is a high-level block diagram illustrating an exemplary architecture of a deep convolutional network configured as a classifier in accordance with an aspect of the present disclosure.

FIGS. 8-9 are flow diagrams illustrating exemplary processes for dynamically updating a classifier in accordance with aspects of the present disclosure.

FIG. 10 is a flow diagram illustrating a method for configuring a classifier in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of, or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

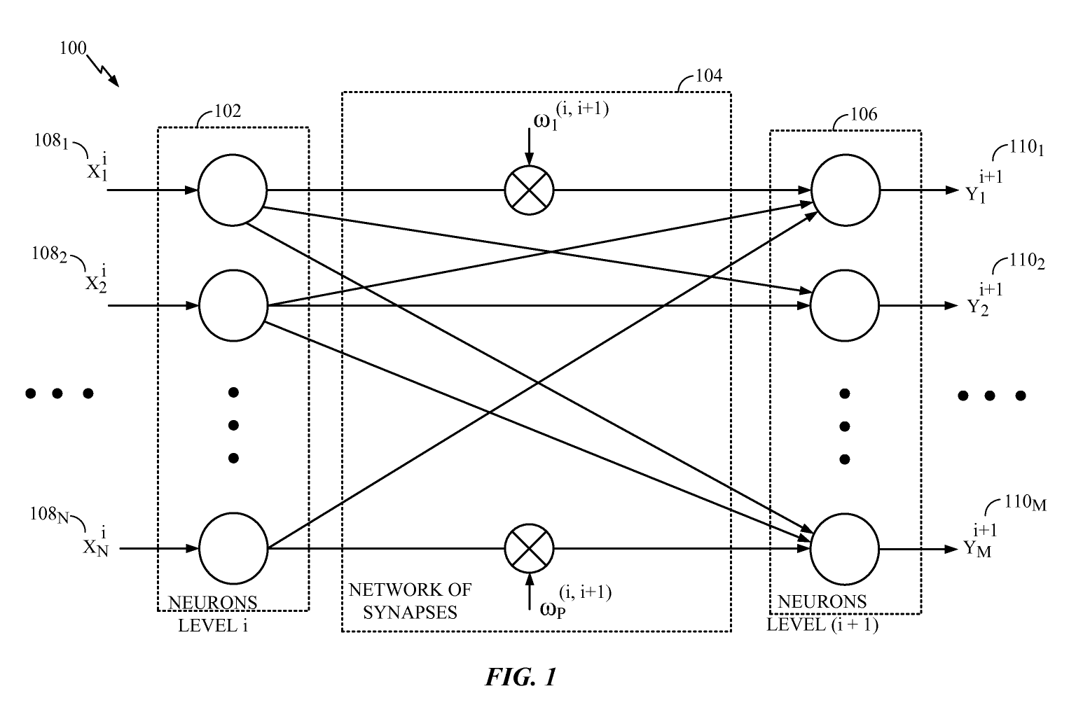

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (e.g., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. The input current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. The signal is typically a function of the membrane potential. Such behavior can be emulated or simulated in hardware and/or software, including analog and digital implementations such as those described below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (e.g., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

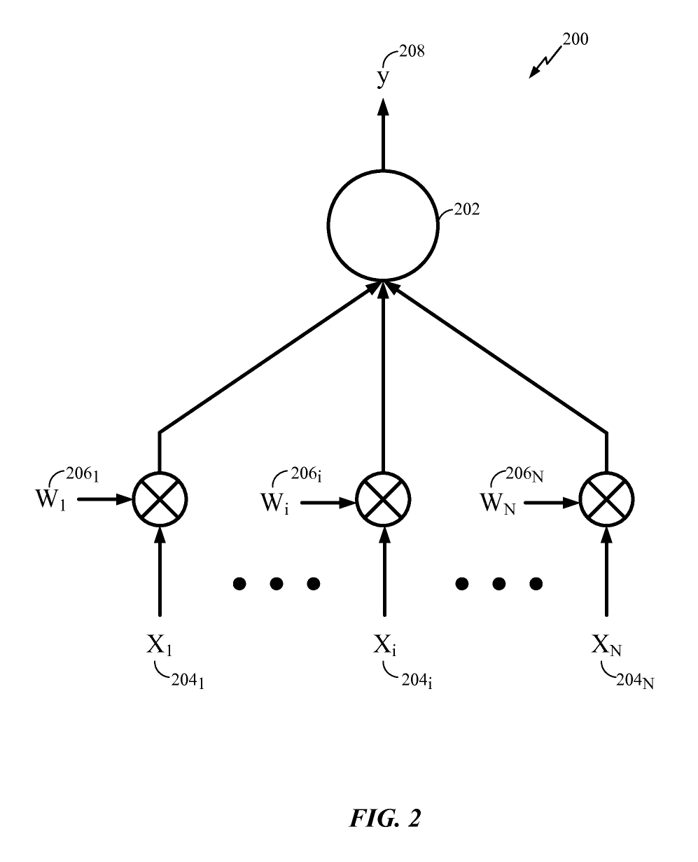

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N}, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁₋M_{N}), where N may be a total number of input connections of the neuron 202.

The neuron 202 may combine the scaled input signals and use the combined scaled inputs to generate an output signal 208 (e.g., a signal Y). The output signal 208 may be a current, a conductance, a voltage, a real-valued, and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (e.g., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Dynamically Updating Classifier Complexity

The present disclosure is directed to dynamically updating the computational complexity of a classifier. A classifier is a device or system that receives an input (e.g., an observation) and identifies one or more categories (or features) to which that input belongs. In some aspects, the identification may be based on a training set of data including observations for which a classification is known.

A classifier may take various forms including support vector networks and neural networks. For example, in some aspects, a classifier may take the form of a deep neural network such as a deep belief network (DBN) or a deep convolutional network.

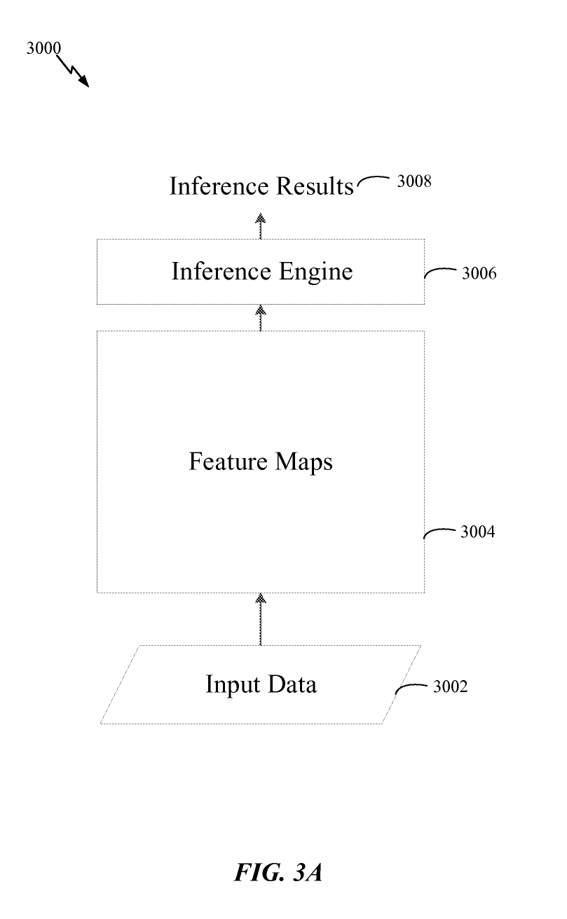

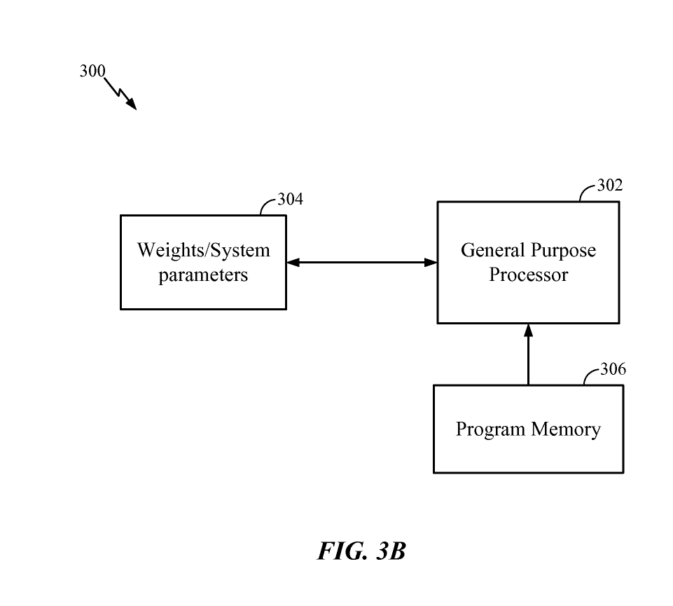

FIG. 3A is a high-level block diagram illustrating an exemplary architecture for a classifier 3000 in accordance with aspects of the present disclosure. The classifier 3000 may be trained using a training set of examples for which a classification is known.

The exemplary classifier 3000 may receive input data 3002. The input data 3002 may comprise an observation such as an image, a sound or other sensory input data. The input data may be supplied via an audiovisual device such as a camera, voice recorder, microphone, smartphone, or the like.

The input data may be supplied to a learned feature map 3004. The learned feature map 3004 may include features or other characteristics for a known data classification. For example, in an optical character recognition application, the feature map may comprise an array of shapes associated with letters of the alphabet. The learned feature maps may be used to extract one or more features from the input data (e.g., a an image). The extracted features from the input data may then be supplied to an inference engine 3006 which may be determine one or more classifications for the input data based on the extracted features. The inference engine 3006 may output the determined classification as an inference result 3008.

In one example, the classifier 3000 may be configured to classify image data. The classifier 3000 may be trained using a set of images of known animals. Accordingly, a new image (input data) may be supplied to the learned feature map, which may include image characteristics from the training data set of known animals. For example, the feature map may include tusks, claws, tails, facial features or other defining characteristic. The input image data may be compared to the feature map to identify a set of features in the input image data. The set of features may then be supplied to the inference engine 3006 to determine a classification for the image. For example, where the input image includes a four-legged animal with a mane about the face, and a tasseled tail may be classified as a lion.

The classifier 3000 may be configured to make more or less precise classifications (e.g., simply determining that the animal is feline or more specifically determining that the lion is an Asiatic or Masai lion) according to design preference in view of computation, power and/or other considerations.

In accordance with aspects of the present disclosure, a system may initially attempt classification with a relatively simple deep network and may update the classifier's complexity based on confidence metrics.

FIG. 3B illustrates an example implementation 300 of the aforementioned classifier using a general-purpose processor 302 in accordance with certain aspects of the present disclosure. Variables (neural signals), synaptic weights, system parameters associated with a computational network (neural network), delays, frequency bin information, threshold values, confidence metrics, classifier configuration information, and/or classifier parameters may be stored in a memory block 304, while instructions executed at the general-purpose processor 302 may be loaded from a program memory 306. In an aspect of the present disclosure, the instructions loaded into the general-purpose processor 302 may comprise code for operating the classifier to classify an input, determining a confidence metric based on classification of the input, and/or dynamically updating a complexity of the classifier based on the confidence metric.

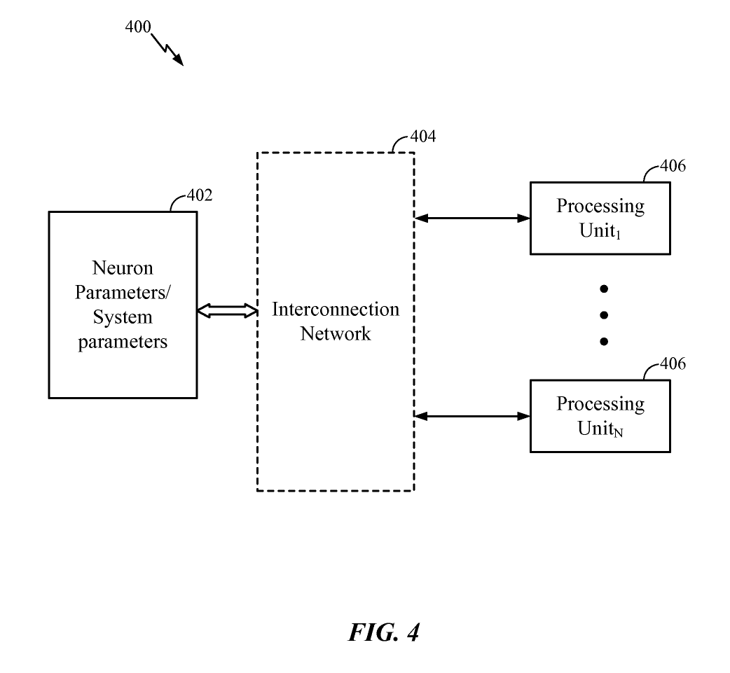

FIG. 4 illustrates an example implementation 400 of the aforementioned configuring a classifier where a memory 402 can be interfaced via an interconnection network 404 with individual (distributed) processing units (neural processors) 406 of a computational network (neural network) in accordance with certain aspects of the present disclosure. Variables (neural signals), synaptic weights, system parameters associated with the computational network (neural network) delays, frequency bin information, threshold values, confidence metrics, classifier configuration information, and/or classifier parameters may be stored in the memory 402, and may be loaded from the memory 402 via connection(s) of the interconnection network 404 into each processing unit (neural processor) 406. In an aspect of the present disclosure, the processing unit 406 may be configured to operate the classifier to classify an input, to determine a confidence metric based on classification of the input, and/or to dynamically update a complexity of the classifier based on the confidence metric.

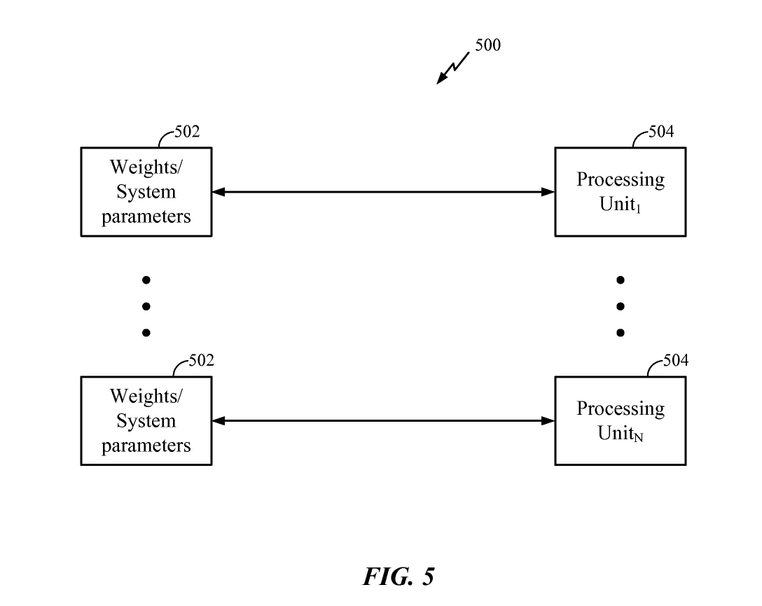

FIG. 5 illustrates an example implementation 500 of the aforementioned configuring a classifier. As illustrated in FIG. 5, one memory bank 502 may be directly interfaced with one processing unit 504 of a computational network (neural network). Each memory bank 502 may store variables (neural signals), synaptic weights, and/or system parameters associated with a corresponding processing unit (neural processor) 504 delays, frequency bin information, threshold values, confidence metrics, classifier configuration information, and/or classifier parameters. In an aspect of the present disclosure, the processing unit 504 may be configured to classify an input, to determine a confidence metric based on classification of the input, and/or to dynamically update a complexity of the classifier based on the confidence metric.

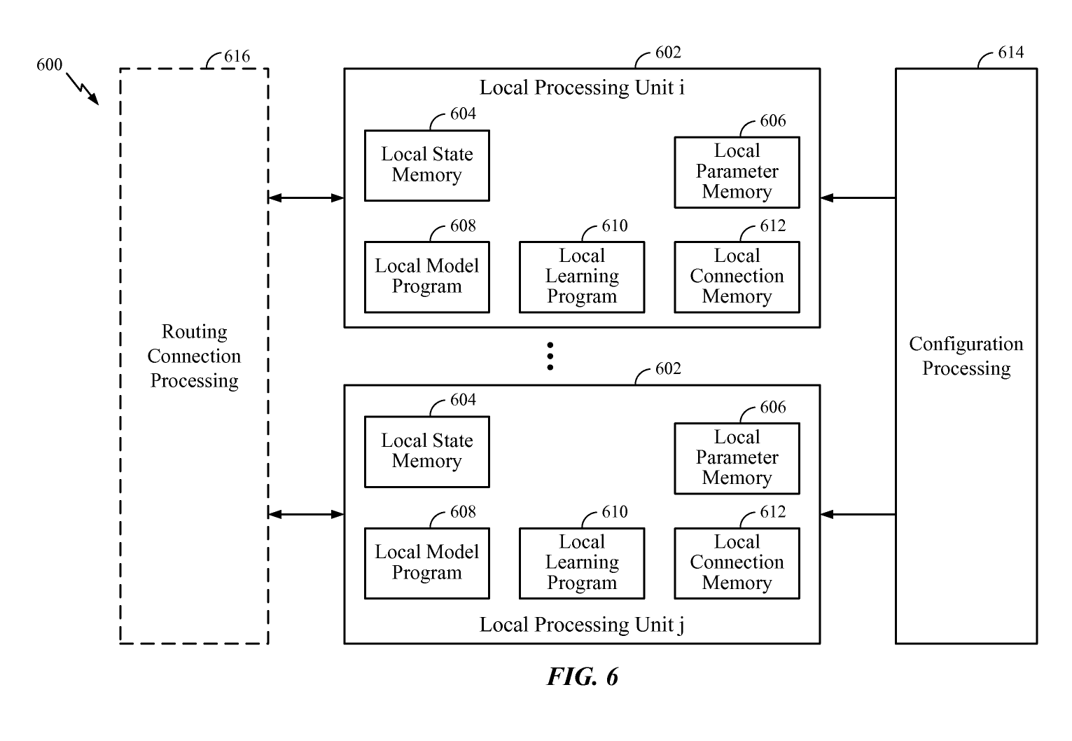

FIG. 6 illustrates an example implementation of a neural network 600 in accordance with certain aspects of the present disclosure. As illustrated in FIG. 6, the neural network 600 may have multiple local processing units 602 that may perform various operations of methods described herein. Each local processing unit 602 may comprise a local state memory 604 and a local parameter memory 606 that store parameters of the neural network. In addition, the local processing unit 602 may have a local (neuron) model program (LMP) memory 608 for storing a local model program, a local learning program (LLP) memory 610 for storing a local learning program, and a local connection memory 612. Furthermore, as illustrated in FIG. 6, each local processing unit 602 may be interfaced with a configuration processor unit 614 for providing configurations for local memories of the local processing unit, and with a routing connection processing unit 616 that provide routing between the local processing units 602.

In one configuration, a processor is configured for operating the classifier to classify an input, determining a confidence metric based on classification of the input, and/or dynamically updating a complexity of the classifier based on the confidence metric. The processor includes operating means, determining means and updating means. In one aspect, the operating means, determining means, and/or updating means may be the general-purpose processor 302, program memory 306, memory block 304, memory 402, interconnection network 404, processing units 406, processing unit 504, local processing units 602, and or the routing connection processing units 616 configured to perform the functions recited. In another configuration, the aforementioned means may be any module or any apparatus configured to perform the functions recited by the aforementioned means.

According to certain aspects of the present disclosure, each local processing unit 602 may be configured to determine parameters of the neural network based upon desired one or more functional features of the neural network, and develop the one or more functional features towards the desired functional features as the determined parameters are further adapted, tuned and updated.

### Confidence Metrics

When performing a classification, a confidence metric may be used to determine if the current classifier complexity is sufficient or if it should be updated. The confidence metric may correspond to an acceptability or accuracy of a classification result. Of course, the present disclosure is not so limited, and other metrics may be used in updating classifier complexity.

### Highest Posterior Probability

In one aspect, the confidence metric may comprise a posterior probability. The posterior probability of a given classification may provide an indication of the confidence in a particular classification decision. In other words, if the posterior probability that an input belongs to a particular class is high, then the confidence in that decision is also high. In such a case, the confidence metric may simply be the highest posterior probability and may be given by:

C(p(c₁|x), . . . ,p(c_{M}|x))=p₁(c|x)ε[0,1], (1)

where M is the total number of classes, p(cᵢ|x) is the posterior probability for class iε{1, . . . , M} and p₁(c|x) is the highest posterior probability for a given input x.

### Log-Ratio of Posterior Probabilities

In some aspects, the log-ratio between the highest and the sum of all the other classification posterior probabilities may be used as a confidence metric. The confidence metric based on the posterior probability log-ratio may be given by:

$$C ( p ( {c}_{1} \vert x ) , … , p ( {c}_{M} \vert x ) ) = log ( \frac{{p}_{1} ( c \vert x )}{{\sum }_{i = 2}^{M} {p}_{i} ( c \vert x )} ) = log ( \frac{{p}_{1} ( c \vert x )}{1 - {p}_{1} ( c \vert x )} ) ∈ ( - ∞ , ∞ ) , \qquad ( 2 )$$

where M is the total number of classes, p(cᵢ|x) is the posterior probability for class iε{1, . . . , M} and p₁(c|x) is the highest posterior probability for a given input x.

### Normalized Difference of Posterior Probabilities

In some aspects of the present disclosure, the normalized difference between the highest and second highest classification posterior probabilities may be used as a confidence metric. The confidence metric based on the normalized posterior probability difference may be expressed as:

$$C ( p ( {c}_{1} \vert x ) , … , p ( {c}_{M} \vert x ) ) = \frac{{p}_{1} ( c \vert x ) - {p}_{2} ( c \vert x )}{{p}_{1} ( c \vert x ) + {p}_{2} ( c \vert x )} ∈ [ 0 , 1 ] , \qquad ( 3 )$$

where M is the total number of classes, p(cᵢ|x) is the posterior probability for class iε{1, . . . , M}, p₁(c|x) is the highest posterior probability and p₂(c|x) is the second highest posterior probability for a given input x.

### Confidence Threshold

In the proposed solution, the confidence metrics are used to determine if the current complexity is sufficient or if it should be increased (or decreased) by comparing the value to a confidence threshold C_{τ}. Therefore, the decision to increase the complexity of the network is based on whether or not

C(p(c₁|x), . . . ,p(c_{M}|x))≦C_{τ}

is true. In other words, if the confidence metric exceeds the threshold C_{τ} then the network complexity is sufficient and is not increased.

### Combined Confidence Metrics

The confidence metrics described above are not mutually exclusive. A combination of two or more confidence or other metrics may be employed such that the complexity of the network is increased when each of the metrics in the combination are satisfied. In one example, the classifier complexity is not increased unless both the highest posterior probability and the normalized difference of the posterior probabilities are below their respective thresholds.

### Classifier Complexity

The complexity of a classifier based on a deep convolutional network (DCN) can be increased in a number of ways. A number of parameters within the DCN may be changed to increase complexity or the architecture itself may be changed.

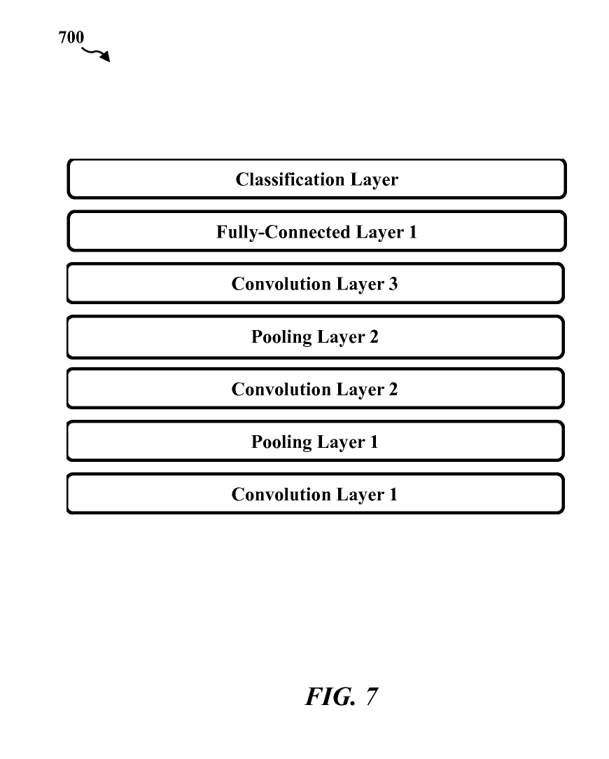

The complexity of an exemplary classifier with layers (e.g., the classifier of FIG. 7) may be updated. The modifications provided here are not meant to be an exhaustive list but instead provide a basis for the exposition of the proposed solution.

### Increasing the Number of Convolutional Layers

The convolutional layers of a DCN perform spatial convolution of their input with a set of convolution layers. It is the convolution operation that generates features that are eventually used by the classification layer. Increasing the number of convolutional layers may increase the number of feature extractions that occur in the DCN and, therefore, may increase the amount of information that can be used by the classification layer. However, the increase in the number of convolutions may significantly increase the number of computations performed in the network.

### Increasing the Number of Convolutional Filters

Within each convolutional layer of the DCN, a number of different filters are used to perform multiple convolutions. Increasing this parameter (i.e., the number of convolution filters) may cause more filters to be used during convolution and, therefore, more convolutions to be computed overall. Computing more convolutions may, in turn, increase the number of features that can be generated by the DCN and, therefore, the amount of information that may be used during classification. However, computing more convolutions may also significantly increase the number of computations performed by the network.

### Decreasing the Stride of Convolutional Layers

When performing spatial convolution in a convolutional layer, the stride defines how many values will be skipped in both the x and y dimensions of the input as each convolution is computed. Decreasing the stride of a convolution filter may cause fewer values to be skipped and more convolutions to be computed. As such, the coverage of the input with the convolution filter may be increased. Therefore, the amount of information passed to the next layer in the DCN may likewise be increased. However, the increased amount of information passed may also significantly increase the total number of computations performed by the network.

### Decreasing the Number of Pooling Layers

The inclusion of a pooling layer between two other layers in a DCN decreases the number of values passed from the preceding layer to the subsequent layer (e.g., sub-sampling). Decreasing the number of pooling layers may decrease the amount of sub-sampling that occurs in the network and may therefore preserve more of the information. However, because more values may be passed to subsequent layers, more computations may be performed.

### Decreasing the Size of Pooling Windows

Within each pooling layer, the pooling window size determines the number of values for which the pooling operation (e.g., sub-sampling) may be applied. Decreasing the pooling window size may cause fewer values to be included in the operation. As less pooling is performed, less data may be sub-sampled and more information may be preserved and passed to the next layer in the DCN. The amount of information lost in the pooling layer may decrease, but the number of computations that are performed may increase.

### Increasing the Number of Fully-Connected Layers

The fully-connected layers of a DCN combine the features generated by the preceding layer. Increasing the number of fully-connected layers increases the number of feature combinations and, therefore, the amount of information that can be used by the classification layer. However, a fully-connected layer greatly increases the number of computations performed by the DCN.

### Increasing the Size of Fully-Connected Layers

The size of each fully-connected layer in a DCN determines the number of features that may be used for classification. Increasing the size of a fully-connected layer increases the number of features and, therefore, the amount of information that can be used by the classification layer. However, increasing the size of a fully-connected layer greatly increases the number of computations performed by the DCN.

### Classifier Selection

A set of classifiers with increasing complexity may be available to the system beforehand. As each classification occurs, the confidence metric may be computed and compared to a threshold. If it does not exceed the threshold, the next most complex classifier is selected. On the other hand, if the confidence metric is above a second threshold, a less complex classifier (e.g., a default classifier) may be selected.

### Classifier Modification

In some aspects, a single classifier with configurable complexity (as described above) may be available to the system beforehand. As each classification occurs, the confidence metric may be computed and compared to a threshold. If the confidence metric does not exceed the threshold, the classifier's complexity may be increased (e.g., the classifier parameters or architecture may be modified).

FIG. 7 illustrates a high-level block diagram for an exemplary deep convolutional network (DCN) 700 configured as a classifier in accordance with aspects of the present disclosure. The DCN 700 may comprise multiple layers of neurons including one or more convolution layers, pooling layers, fully-connected layers and classification layers. In some aspects, the parameters and/or architecture (e.g., the number, type, size of the layers, and/or the interconnections between layers) may be modified to modulate the computational complexity of the DCN.

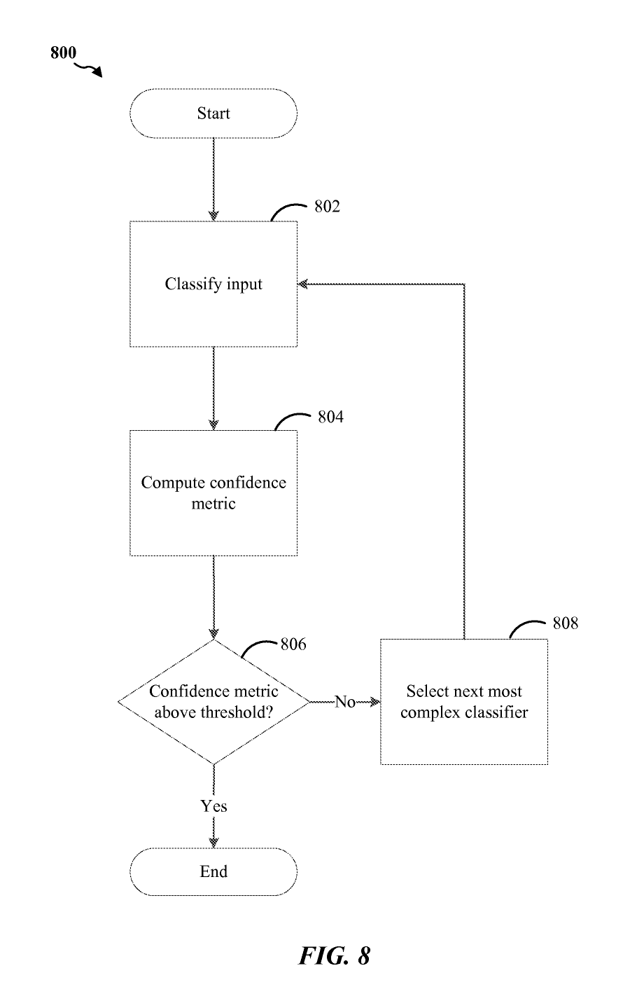

FIG. 8 is a flow diagram illustrating an exemplary process 800 for dynamically updating a classifier in accordance with aspects of the present disclosure. At block 802, the classifier may receive an input to classify. In turn, the classifier may perform a classification operation to classify the input into one or more categories. At block 804, a confidence metric is computed. The confidence metric may be determined based on a posterior probability, as described above, for example.

The confidence metric may then be compared to a threshold value as shown in block 806. When the confidence metric is below the threshold value, at block 808, a more complex classifier may be selected and used for subsequent classification operations. The more complex classifier may be one of a set of preconfigured classifiers organized according to a complexity of the classifiers. In some aspects, the more complex classifier may be used to repeat the classification of the previous input. Accordingly, a more accurate classification may be obtained for the previous input.

On the other hand, if the confidence metric is above the threshold value, the complexity of the classifier may be maintained and may be used to perform a subsequent classification operation. Thereafter, the process may be repeated.

In some aspects, the confidence metric may be compared to an additional threshold. When the confidence metric is above the additional threshold, a less complex classifier may be selected. For example, when the confidence metric indicates 99% confidence or more in the performed classification, a less complex classifier (e.g., a default classifier) may be used to perform subsequent classification operations. As such, computational complexity and power consumption may be reduced.

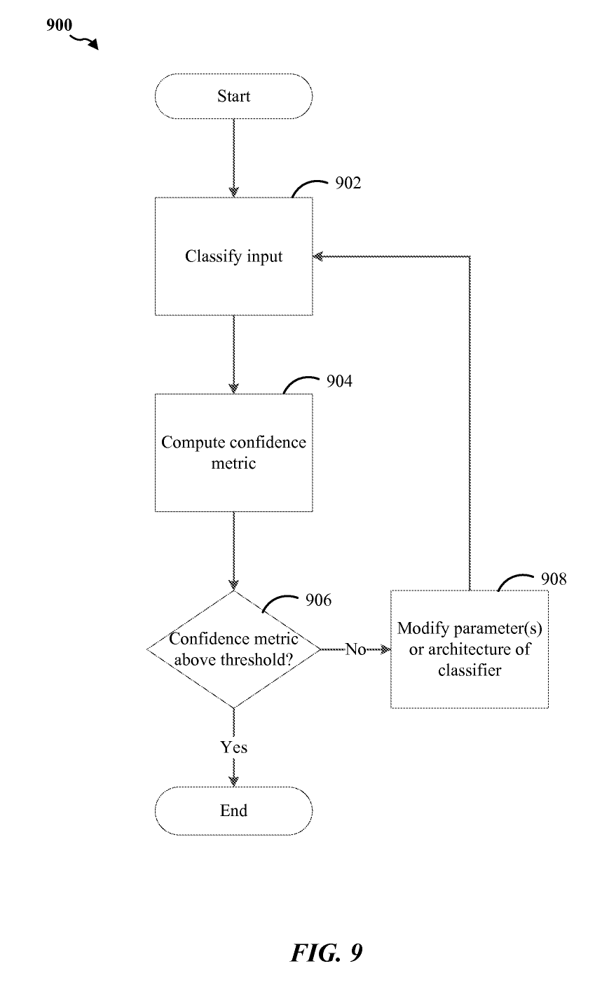

FIG. 9 is a flow diagram illustrating an exemplary process 900 for dynamically updating a classifier in accordance with aspects of the present disclosure. At block 902, the classifier may receive an input to classify. In turn, the classifier may perform a classification operation to classify the input into one or more categories. At block 904, a confidence metric is computed. The confidence metric may be determined based on a posterior probability, as described above, for example.

The confidence metric may then be compared to a threshold value as shown in block 906. When the confidence metric is below the threshold value, the complexity of the classifier may be updated, for example, by modifying the parameters of the classifier and/or the architecture of the classifier as shown at block 908. Thereafter, the resulting updated classifier may be used to perform subsequent classification operations. In some aspects, the updated classifier may be used to repeat the classification of the previous input. Thus, a more accurate classification may be obtained for the previous input.

On the other hand, if the confidence metric is above the threshold value, the complexity of the classifier may be maintained and may be used to perform a subsequent classification operation. Thereafter, the process may be repeated.

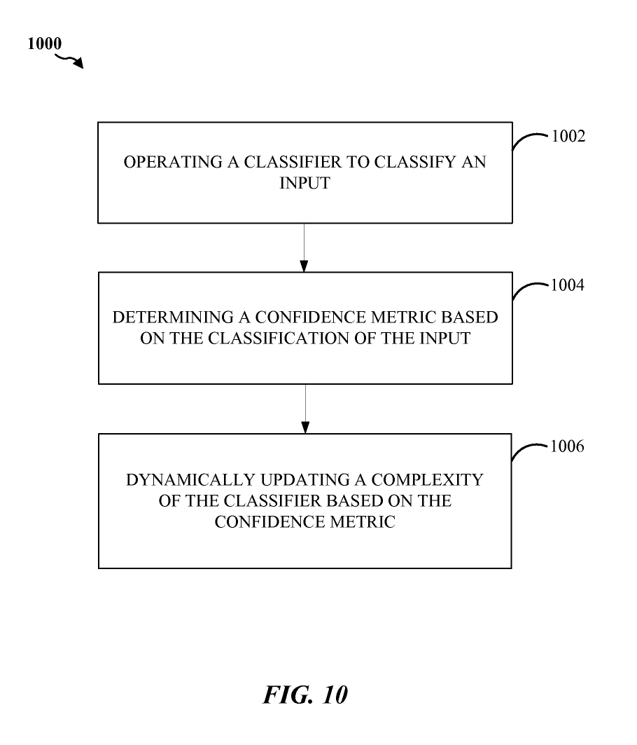

FIG. 10 illustrates a method 1000 for configuring a classifier. In block 1002, the process operates the classifier to classify an input. In block 1004, the process determines a confidence metric based on classification of the input. In some aspects, the confidence metric may be determined based on a posterior probability.

Furthermore, in block 1006, the process dynamically updates the complexity of the classifier based on the confidence metric. In some aspects, the complexity of the classifier may be increased when the confidence metric is below a threshold value. Increasing the complexity may, for example, include increasing a number of parameters for the classifier, changing the values of existing parameters of the classifier, changing the architecture of the classifier or a combination thereof

In a further example, the complexity may also be increased by changing the architecture of the classifier. For instance, the architecture may be changed by increasing the number of convolution layers of the classifier, decreasing the stride of one or more convolution filters, by adding pooling layers or fully-connected layers, or by adjusting the size of the convolution layers or pooling layers.

In some aspects, the classifier may be dynamically updated by decreasing a complexity of the classifier when the confidence metric is above a second threshold. For example, a default network may be specified for the next classification operation.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for configuring a classifier, comprising:
operating the classifier to classify an input;
determining a confidence metric based at least in part on classification of the input; and
dynamically updating a complexity of the classifier based at least in part on the confidence metric.

2. The method of claim 1, in which the confidence metric is based at least in part on a posterior probability.

3. The method of claim 1, in which the dynamically updating comprises increasing the complexity of the classifier when the confidence metric is below a threshold value.

4. The method of claim 3, in which increasing the complexity comprises at least one of increasing a number of parameters for the classifier, changing values of existing parameters of the classifier, or a combination thereof.

5. The method of claim 3, in which increasing the complexity comprises changing an architecture of the classifier.

6. The method of claim 5, in which changing the architecture comprises at least one of increasing a number of convolution layers of the classifier, decreasing a stride of a convolution filter, or a combination thereof.

7. The method of claim 1, in which the updating comprises decreasing the complexity of the classifier when the confidence metric is above a threshold value.

8. An apparatus for configuring a classifier, comprising:
a memory; and
at least one processor coupled to the memory, the at least one processor being configured:
to operate the classifier to classify an input;
to determine a confidence metric based at least in part on classification of the input; and
to dynamically update a complexity of the classifier based at least in part on the confidence metric.

9. The apparatus of claim 8, in which the at least one processor is further configured to determine the confidence metric based at least in part on a posterior probability.

10. The apparatus of claim 8, in which the at least one processor is further configured to dynamically update the complexity by increasing the complexity of the classifier when the confidence metric is below a threshold value.

11. The apparatus of claim 10, in which the at least one processor is further configured to increase the complexity by at least one of increasing a number of parameters for the classifier, changing values of existing parameters of the classifier, or a combination thereof.

12. The apparatus of claim 10, in which the at least one processor is further configured to increase the complexity by changing an architecture of the classifier.

13. The apparatus of claim 12, in which the at least one processor is further configured to change the architecture by at least one of increasing a number of convolution layers of the classifier, decreasing a stride of a convolution filter, or a combination thereof.

14. The apparatus of claim 8, in which the at least one processor is further configured to dynamically update the complexity by decreasing the complexity of the classifier when the confidence metric is above a threshold value.

15. An apparatus for configuring a classifier, comprising:
means for operating the classifier to classify an input;
means for determining a confidence metric based at least in part on classification of the input; and
means for dynamically updating a complexity of the classifier based at least in part on the confidence metric.

16. The apparatus of claim 15, in which the confidence metric is based at least in part on a posterior probability.

17. The apparatus of claim 15, in which the updating means increases the complexity of the classifier when the confidence metric is below a threshold value.

18. The apparatus of claim 17, in which the updating means increases the complexity by at least one of increasing a number of parameters for the classifier, changing values of existing parameters of the classifier, or a combination thereof.

19. The apparatus of claim 17, in which the updating means increases the complexity by changing an architecture of the classifier.

20. The apparatus of claim 19, in which changing the architecture comprises at least one of increasing a number of convolution layers of the classifier, decreasing a stride of a convolution filter, or a combination thereof.

21. The apparatus of claim 15, in which the updating means decreases the complexity of the classifier when the confidence metric is above a threshold value.

22. A computer program product for configuring a classifier, comprising:
a non-transitory computer readable medium having encoded thereon program code, the program code comprising:
program code to operate the classifier to classify an input;
program code to determine a confidence metric based at least in part on classification of the input; and
program code to dynamically update a complexity of the classifier based at least in part on the confidence metric.

23. The computer program product of claim 22, further comprising program code to determine the confidence metric based at least in part on a posterior probability.

24. The computer program product of claim 22, further comprising program code to dynamically update the complexity by increasing the complexity of the classifier when the confidence metric is below a threshold value.

25. The computer program product of claim 24, in which the program code to increase the complexity comprises program code to at least one of increase a number of parameters for the classifier, change values of existing parameters of the classifier, or a combination thereof.

26. The computer program product of claim 24, in which the program code to increase the complexity comprises program code to increase the complexity by changing an architecture of the classifier.

27. The computer program product of claim 26, in which changing the architecture comprises at least one of increasing a number of convolution layers of the classifier, decreasing a stride of a convolution filter, or a combination thereof.

28. The computer program product of claim 22, further comprising program code to dynamically update the complexity by decreasing the complexity of the classifier when the confidence metric is above a threshold value.
